(19) United States
(12) Patent Application Publication
(10) Pub. No.: US 2021/0049195 A1
(43) Pub. Date: Feb. 18, 2021

(54) COMPUTER-READABLE RECORDING MEDIUM RECORDING ANSWERING PROGRAM, ANSWERING METHOD, AND ANSWERING DEVICE

(71) Applicant: FUJITSU LIMITED, Kawasaki-shi (JP)

(72) Inventors: Shinichi KAWAKAMI, Chiba (JP); Miyuki YAMADA, Shinagawa (JP)

(73) Assignee: FUJITSU LIMITED, Kawasaki-shi (JP)

(21) Appl. No.: 17/086,789

(22) Filed: Nov. 2, 2020

Related U.S. Application Data
(63) Continuation of application No. PCT/JP2018/018616, filed on May 14, 2018.

(51) Int. Cl. G06F 16/332; H04L 12/58; G09B 7/00; G06F 16/33

(52) U.S. Cl. CPC G06F 16/3329; G06F 16/3344; G09B 7/00; H04L 51/02

(57) ABSTRACT

A non-transitory computer-readable recording medium stores therein an answering program for causing a computer to execute a process including: receiving an inquiry from a terminal; referring to a memory that stores a content of an inquiry and an answer candidate for the inquiry in association with each other, and judging whether or not an answer candidate for the received inquiry is present; referring to a past inquiry history and determining information to be outputted to the terminal when it is judged that the answer candidate is absent; and outputting the determined information.

### CROSS-REFERENCE TO RELATED APPLICATION

This application is a continuation application of International Application PCT/JP2018/018616 filed on May 14, 2018 and designated the U.S., the entire contents of which are incorporated herein by reference.

### FIELD

The embodiment discussed herein is related to an answering program, an answering method, and an answering device.

### BACKGROUND

In the related art, there have been used manned systems such as call centers that receive and respond to inquiries from end users of mail order, online sales, online games, and the like and inquiries from administrators regarding system failures or the like, by telephone, e-mail, or the like. In recent years, there is known a frequently asked questions (FAQ) by-conversation system by a computer that enables responding to an inquiry from an end user, an administrator, or the like even outside of manned business hours.

Japanese Laid-open Patent Publication No. 2014-29668 and Japanese Laid-open Patent Publication No. 2009-48303 are disclosed as related art.

### SUMMARY

According to an aspect of the embodiments, a non-transitory computer-readable recording medium stores therein an answering program for causing a computer to execute a process including: receiving an inquiry from a terminal; referring to a memory that stores a content of an inquiry and an answer candidate for the inquiry in association with each other, and judging whether or not an answer candidate for the received inquiry is present; referring to a past inquiry history and determining information to be outputted to the terminal when it is judged that the answer candidate is absent; and outputting the determined information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for explaining a frequently asked questions (FAQ) system according to Example 1;

FIG. 2 is a functional block diagram illustrating a functional configuration of an answering device according to Example 1;

FIG. 3 is a view illustrating an example of information stored in an FAQ list database (DB);

FIG. 4 is a view illustrating an example of information stored in a chat handling DB;

FIG. 5 is a view illustrating an example of a chatbot screen;

FIG. 6 is a view illustrating an example of a handling list in a case of incomprehension;

FIG. 7 is a flowchart illustrating a flow of processing;

FIG. 8 is a view for explaining a comparative example between an Example and a general technique at a time of an inquiry that does not correspond to an FAQ;

FIG. 9 is a view for explaining a motion example of an avatar; and

FIG. 10 is a diagram for explaining a hardware configuration example.

### DESCRIPTION OF EMBODIMENTS

However, in the FAQ system described above, in a case where an unexpected inquiry is inputted, it is not possible to make an appropriate response. Therefore, conversation is not continued between the system and the user, and a user's true inquiry may not be recognized. Therefore, an event such as the FAQ system being forcibly terminated by the user occurs, and an appropriate answer may not be presented to the user.

In one aspect, an answering program, an answering method, and an answering device capable of continuing a conversation with a user even for an unexpected inquiry may be provided.

Hereinafter, Examples of an answering program, an answering method, and an answering device according to an embodiment will be described in detail with reference to the drawings. Note that the embodiment is not limited to these Examples. Furthermore, each Example may be appropriately combined within a range without inconsistency.

### Example 1

[Overall Configuration]

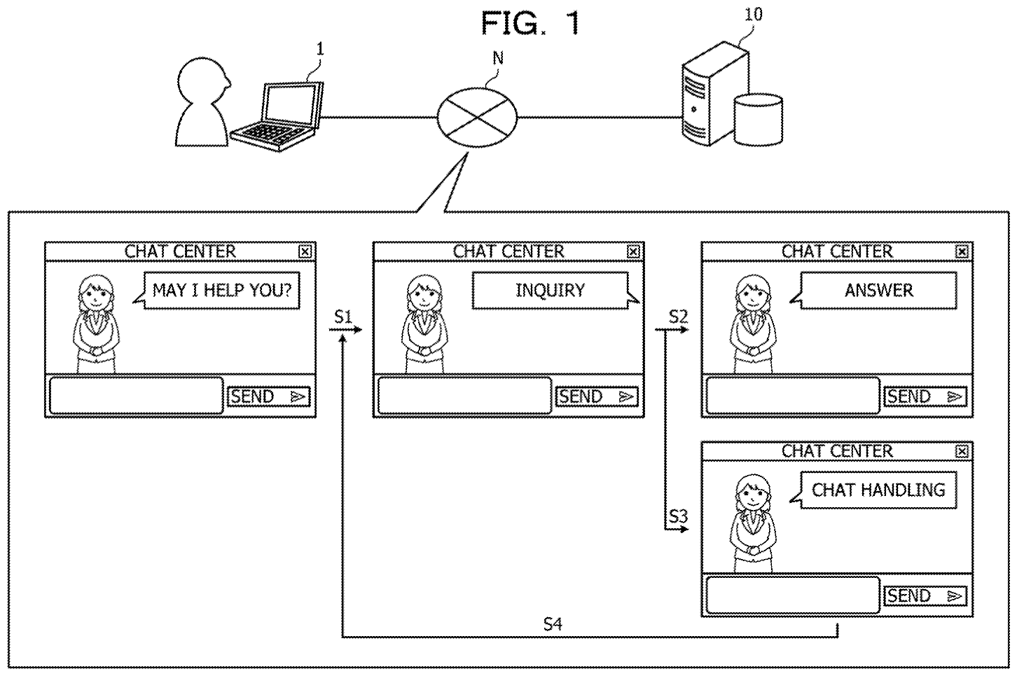

FIG. 1 is a view for explaining a frequently asked questions (FAQ) system according to Example 1. As illustrated in FIG. 1, the FAQ system is a system in which a user terminal 1 and an answering device 10 are connected via a network N. This FAQ system is a system in which the answering device 10 receives an inquiry from the user terminal 1 by conversation, and responds to the user terminal 1 with an answer to the inquiry. Note that examples of inquiry include a question from an end user of mail order, an online sale, an online game, and the like, a question from an administrator regarding a system failure or the like, and the like. Furthermore, as the network N, various communication networks such as the Internet or a dedicated line can be adopted regardless of whether the network is wired or wireless.

The user terminal 1 is an example of a computer device used by a user, and is, for example, a personal computer, a smartphone, or the like. This user terminal 1 uses a Web browser or a dedicated application to access the answering device 10, to input an inquiry and acquire an answer.

The answering device 10 is an example of a computer device that answers to an inquiry inputted from the user terminal 1. When receiving access from the user terminal 1, this answering device 10 displays a chatbot screen, which is an example of a Web screen by conversation, on the user terminal 1. Then, when receiving an inquiry from the user terminal 1 on the chatbot screen, the answering device 10 searches a database for an answer candidate corresponding to the inquiry, and outputs the retrieved answer candidate on the chatbot screen. In this way, the answering device 10 may provide an environment in which an inquiry may be answered at any time at a user's timing regardless of business hours or the like.

In such an FAQ system, when an answer candidate corresponding to the inquiry inputted from the user terminal 1 is stored in an FAQ list, the answering device 10 responds the answer candidate. Whereas, when the answer candidate corresponding to the inquiry is not stored in the FAQ list, the answering device 10 executes chat handling for continuing conversation with the user.

For example, as illustrated in FIG. 1, the answering device 10 displays a message “May I help you?” on the chatbot screen shared with the user terminal 1, and the user terminal 1 inputs a content of “inquiry” on the chatbot screen (S1). Then, the answering device 10 searches a database for an answer corresponding to the inputted inquiry, and the retrieved answer is outputted to the chatbot screen when the corresponding answer can be retrieved (S2).

Whereas, when the answering device 10 may not retrieve the answer corresponding to the inputted inquiry from the database, the answering device 10 executes chat handling (S3), and causes transition to the inquiry reception again (S4). For example, the answering device 10 identifies a category of the content inputted as the inquiry, randomly selects a message corresponding to the category, and outputs the message to continue the conversation. More specifically, for example, the answering device 10 prepares in advance a plurality of categories of “greeting type” such as “Hello”, “anger type” such as “Don't be silly”, and the like, and response messages corresponding to the categories. Then, the answering device 10 executes morphological analysis or the like of the content inputted as the inquiry, judges which category the inquiry corresponds to, and outputs a message corresponding to the category.

In this way, the answering device 10 may continue the conversation on the chatbot screen even when receiving an unintended inquiry. Therefore, since it is possible to inhibit forcible termination of the chatbot due to output of an answer that make the user feel uncomfortable such as “I don't understand” to an unexpected inquiry, the answering device 10 may continue conversation with the user even for an unexpected inquiry, and a possibility of inducing a true inquiry of the user may be increased.

[Functional Configuration]

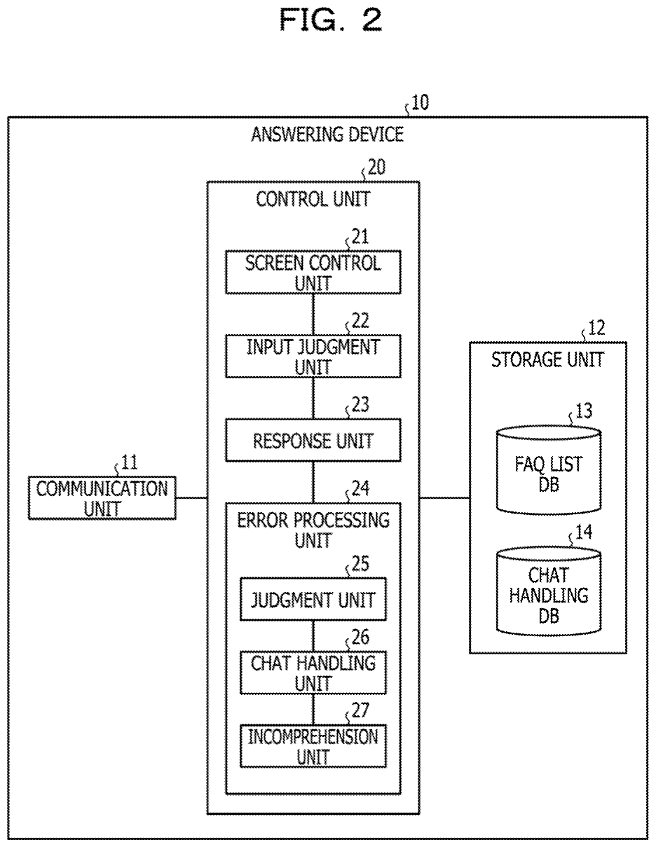

Next, a functional configuration of the FAQ system according to Example 1 will be described. Note that, since the user terminal 1 has a configuration similar to that of a general computer device, detailed description will be omitted. FIG. 2 is a functional block diagram illustrating a functional configuration of the answering device 10 according to Example 1. As illustrated in FIG. 2, the answering device 10 includes a communication unit 11, a storage unit 12, and a control unit 20.

The communication unit 11 is a processing unit that controls communication between with the user terminal 1 and is, for example, a communication interface or the like. For example, the communication unit 11 establishes web communication between with the user terminal 1, and transmits and receives data.

The storage unit 12 is an example of a storage device that stores programs and data and is, for example, a memory, a hard disk, or the like. This storage unit 12 stores an FAQ list database (DB) 13 and a chat handling DB 14.

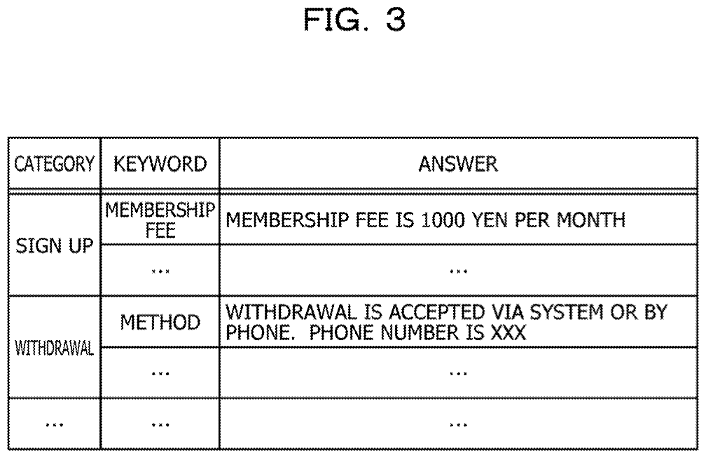

The FAQ list DB 13 is a database that stores an FAQ list that associates inquiries with formal answers corresponding to the inquiries. FIG. 3 is a view illustrating an example of information stored in the FAQ list DB 13. As illustrated in FIG. 3, the FAQ list DB 13 stores “category, keyword, answer” in association with each other. The “category” stored here indicates a category of the FAQ. The “keyword” is a keyword for searching the FAQ, and is used when searching for an answer to an inquiry received from the user terminal 1. The “answer” is a formal answer candidate for an inquiry received from the user terminal 1, and may be identified from past cases and the like.

In the example of FIG. 3, a keyword “membership fee” is assigned to an answer “The membership fee is 1000 yen per month.” corresponding to a category “sign up”. Furthermore, to an answer “Withdrawal is accepted via the system or by phone. The phone number is XXX.” corresponding to a category “withdrawal”, a keyword “method” is assigned. Note that the method of classifying the categories and the association between the keywords and the answers are examples, and the setting may be changed in any ways.

The chat handling DB 14 is a database that stores information related to chat handling that is used when an unexpected inquiry that is not expected as an inquiry (hereinafter, also referred to as an unexpected inquiry) is received. Note that, for the information stored in the chat handling DB 14, an answer when the conversation has been continued may be used, from an answer history for unexpected inquiries received in the past.

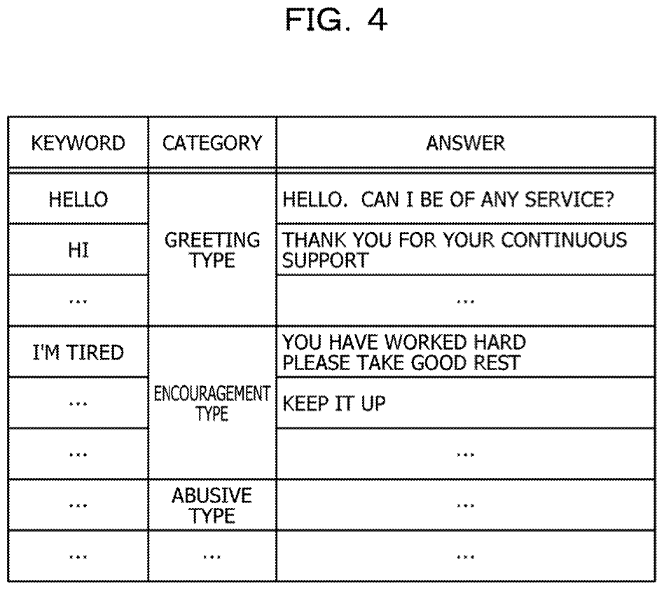

FIG. 4 is a view illustrating an example of information stored in the chat handling DB 14. As illustrated in FIG. 4, the chat handling DB 14 stores “input content, category, answer” in association with each other. The “input content” stored here is a content of an Inquiry inputted to the chatbot, and is a content of an unexpected inquiry determined to have no corresponding answer in the FAQ list DB 13. The “category” indicates a category corresponding to the chat handling. The “answer” is an answer candidate of the chat handling for the inquiry received from the user terminal 1.

The example of FIG. 4 indicates that, when an unexpected inquiry “Hello” is inputted, it is judged as a category of “greeting type”, and corresponding “Hello, Can I be of any service?”, “Thank you for your continuous support”, or the like is outputted as an answer. Furthermore, when “Im tired”, which is an unexpected inquiry, is inputted, it is judged as a category of “encouragement type”, and a corresponding answer “You have worked hard. Please take a good rest.” or “Keep it up.” is outputted as an answer. Note that the method of classifying the categories and the association between the input contents and the answers are examples, and the setting may be changed in any ways.

The control unit 20 is a processing unit that controls the entire answering device 10 and is, for example, a processor or the like. This control unit 20 has a screen control unit 21, an input judgment unit 22, a response unit 23, and an error processing unit 24. Note that the screen control unit 21, the input judgment unit 22, the response unit 23, and the error processing unit 24 are examples of electronic circuits such as a processor, and examples of processes performed by the processor.

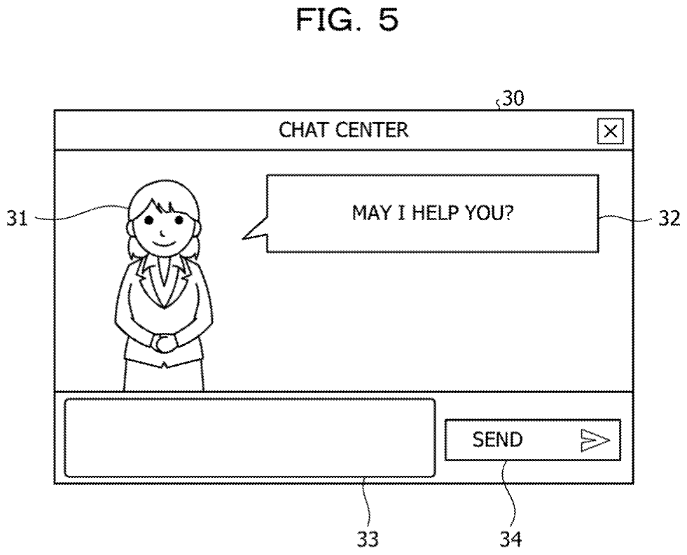

The screen control unit 21 is a processing unit that controls the chatbot screen between with the user terminal 1. For example, when receiving access to the FAQ system from the user terminal 1, the screen control unit 21 transmits a chatbot screen 30 illustrated in FIG. 5 to the user terminal 1. Then, the screen control unit 21 executes receiving of an inquiry or the like, outputting of an answer, or the like on the chatbot screen 30.

FIG. 5 is a view illustrating an example of the chatbot screen 30. As illustrated in FIG. 5, the chatbot screen 30 includes an avatar 31, a chat area 32, an input area 33, and a send button 34. The avatar 31 is a character that acts so as to answer an inquiry from a user. The chat area 32 is an area in which an answer including a message and the like from the answering device 10 and an inquiry including a message and the like inputted from the user terminal 1 are outputted and displayed in an input order. The input area 33 is an area in which the user inputs an inquiry or the like via the user terminal 1. The send button 34 is a button to execute outputting of the inquiry or the like inputted to the input area 33, to the chat area 32.

The input judgment unit 22 is a processing unit that judges whether or not an inquiry or the like inputted to the chat area 32 of the chatbot screen 30 is included in the FAQ prepared in advance. In other words, for example, the input judgment unit 22 judges whether the received inquiry is an expected inquiry or an unexpected inquiry.

Specifically, for example, when a word is inputted as an inquiry, the input judgment unit 22 judges whether or not the word is registered as a keyword in the FAQ list DB 13. For example, when “membership fee” is inputted as an inquiry, the input judgment unit 22 judges whether or not “membership fee” is registered as a keyword in the FAQ list DB 13.

Furthermore, when an inquiry sentence is inputted, the input judgment unit 22 executes morphological analysis or the like to extract a word, and judges whether or not each of the extracted words is registered as a keyword in the FAQ list DB 13. For example, when an inquiry sentence “How much is the monthly fee or the annual fee?” is inputted, the input judgment unit 22 executes morphological analysis or the like to extract words “membership fee, monthly fee, annual fee, how much”, and judges whether or not each of the extracted words “membership fee, monthly fee, annual fee, how much” is registered as a keyword in the FAQ list DB 13.

Then, when it is judged that there is registration in the keyword of the FAQ list DB 13, the input judgment unit 22 outputs the corresponding keyword to the response unit 23. Whereas, when it is judged that there is no registration in the keyword of the FAQ list DB 13, that is, for example, there are 0 hits, the input judgment unit 22 determines as an unexpected inquiry, and instructs the error processing unit 24 to start error processing.

The response unit 23 is a processing unit that acquires a response corresponding to the inputted user inquiry from the FAQ list DB 13 and responds. For example, when receiving a keyword “membership fee” from the input judgment unit 22, the response unit 23 acquires the answer “The membership fee is 1000 yen per month.” from the FAQ list DB 13, which is associated with “membership fee”, and outputs to the chat area 32 of the chatbot screen 30.

Furthermore, when receiving a plurality of keywords from the input judgment unit 22, the response unit 23 identifies a category to which each keyword belongs from the FAQ list DB 13, and outputs a response corresponding to a category that is most frequently identified, to the chat area 32 of the chatbot screen 30. For example, the response unit 23 identifies each category to which each word included in the inquiry sentence belongs, and randomly responds an answer in the most frequent category.

As another example, when receiving a plurality of keywords from the input judgment unit 22, the response unit 23 identifies individual answers associated with individual keywords. Then, the response unit 23 outputs, among individual answers, an answer containing the received keywords most, to the chat area 32 of the chatbot screen 30. For example, among individual words included in an inquiry sentence “How much is the monthly fee or the annual fee?”, multiple words included in the inquiry sentence are included in the answer “The membership fee is 1000 yen per month.” corresponding to the keyword “membership fee”. Therefore, the response unit 23 preferentially responds this answer. Note that the response method exemplified here is an example, and a general FAQ system answer method can be adopted.

The error processing unit 24 is a processing unit that includes a judgment unit 25, a chat handling unit 26, and an incomprehension unit 27, and executes error processing when the input judgment unit 22 judges that a keyword corresponding to the inputted inquiry is not registered in the FAQ list DB 13. In other words, for example, the error processing unit 24 executes the error processing when an unexpected inquiry is received and there are 0 hits for the answer.

The judgment unit 25 is a processing unit that judges whether or not an unexpected inquiry determined by the input judgment unit 22 to have no corresponding answer in the FAQ list is registered in the chat handling DB 14. In other words, for example, when the FAQ corresponding to the inputted inquiry is not registered, the judgment unit 25 judges whether or not there is registration as chat handling.

For example, when an unexpected inquiry such as “Hello” or a word similar to “Hello” (for example, hellow or hello) is inputted, the judgment unit 25 judges whether or not there is registration in the input content of the chat handling DB 14. Then, the judgment unit 25 instructs the chat handling unit 26 for the chat handling when it is judged that there is registration in the chat handling DB 14, and instructs the incomprehension unit 27 to perform incomprehension handling when it is judged that there is no registration in the chat handling DB 14. Note that, as a similarity judgment method, various known methods such as morphological analysis and the number of matching characters may be adopted.

The chat handling unit 26 is a processing unit that executes chat handling when the chat handling is received from the judgment unit 25. In other words, for example, the chat handling unit 26 continuously generates opportunities to receive an input of an expected inquiry by chatting with the user and continuing a conversation, even when receiving an unexpected inquiry.

Specifically, for example, when “Hello” is inputted to the chatbot screen 30, which is an unexpected inquiry that is registered in the keyword of the FAQ list DB 13, the chat handling unit 26 refers to the chat handling DB 14 to identify the category “greeting type” associated with “Hello”. Then, the chat handling unit 26 acquires, from the chat handling DB 14, an answer “Thank you for your continuous support.” randomly selected from a plurality of answers associated with the category “greeting type”, and outputs to the chat area 32 of the chatbot screen 30.

In this way, by making answers to unexpected inquiries non-uniform, the chat handling unit 26 may reduce discomfort of the user, and may prompt for a new input and prompt for an input of a true inquiry.

The incomprehension unit 27 is a processing unit that executes the incomprehension handling when the incomprehension handling is received from the judgment unit 25. For example, the incomprehension unit 27 judges, as being incomprehensible, an inquiry for which an answer candidate is not stored in the FAQ list DB 13 and which is not registered in the chat handling DB 14, and executes the incomprehension handling for the inquiry. In other words, for example, even in a case of an inquiry that may not be expected and makes no sense, the incomprehension unit 27 avoids forcible termination by the user and expects another inquiry input, by giving some kind of response.

Specifically, for example, when “Gud moning” or “H-E-L” that is not registered in the FAQ list DB 13 or the chat handling DB 14 is inputted in the chatbot screen 30, the incomprehension unit 27 randomly outputs a predetermined answer as the incomprehension handling. Note that the “Gud moning” is an example of a coined word for “Good morning”, and “H-E-L” is an example of a coined word for “HELLO”.

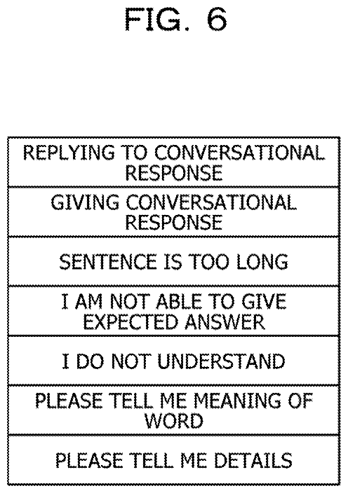

FIG. 6 is a view illustrating an example of a handling list in a case of incomprehension. As illustrated in FIG. 6, as a handling list in a case of incomprehension, categories are prepared such as “replying to a conversational response, giving a conversational response, the sentence is too long, I am not able to give an expected answer, I do not understand, please tell me the meaning of the word, please tell me the details”. Then, the incomprehension unit 27 randomly selects a category corresponding to the inquiry judged to be incomprehensible from the handling list, and outputs a message or the like corresponding to the selected category to the chat area 32 of the chatbot screen 30. Note that the selection of the category may be selection based on a result of morphological analysis, a dictionary prepared in advance, or the like, or the category itself may be randomly selected. Furthermore, it is also possible to prepare an answer list in advance instead of the category.

For example, the incomprehension unit 27 responds “Yes, that's right” when “replying to a conversational response” is selected, responds “Yes it is” when “giving a conversational response” is selected, and responds “the sentence is too long, please try again.” or the like when “the sentence is too long” is selected. At this time, the incomprehension unit 27 may also execute morphological analysis on a question sentence inputted as an inquiry without randomly selecting a category, and may select and judge which category the inquiry belongs to.

[Flow of Processing]

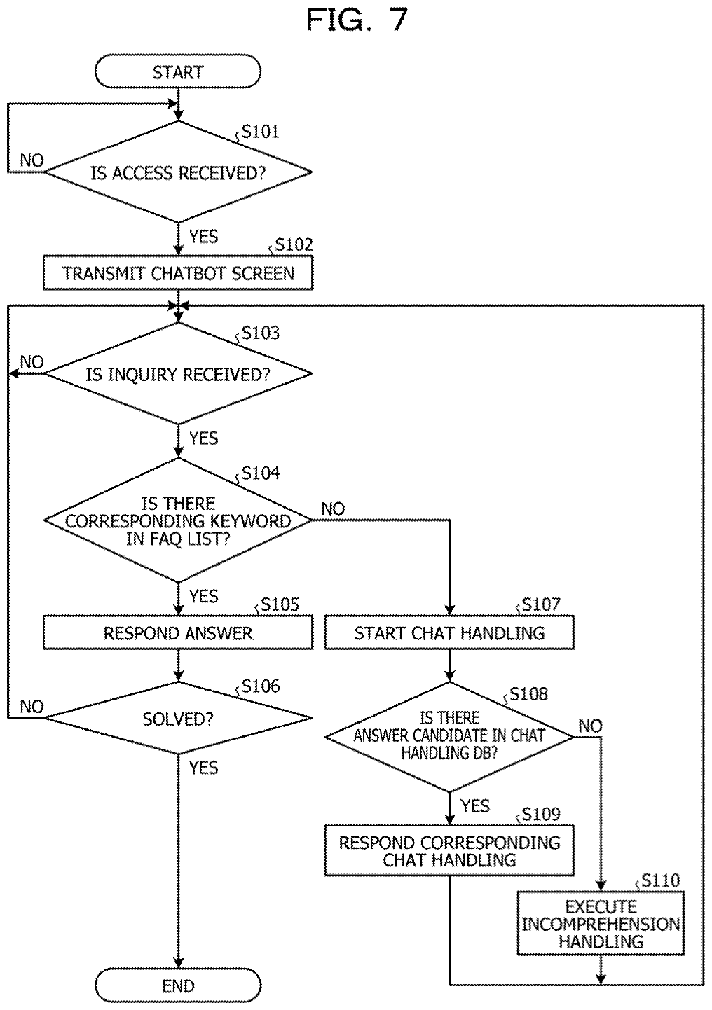

FIG. 7 is a flowchart illustrating a flow of processing. As illustrated in FIG. 7, when the screen control unit 21 of the answering device 10 receives access from the user terminal 1 (S101: Yes), the screen control unit 21 transmits the chatbot screen 30 to the user terminal 1 (S102).

Thereafter, when an inquiry from the user terminal 1 is received on the chatbot screen 30 (S103: Yes), the input judgment unit 22 judges whether or not the received inquiry is registered in the FAQ list DB 13 (S104).

Then, when the input judgment unit 22 judges that the received inquiry is registered in the FAQ list DB 13 (S104: Yes), the response unit 23 acquires a corresponding answer from the FAQ list DB 13, and outputs to the chatbot screen 30 (S105).

Thereafter, when the response unit 23 receives an input of a message indicating that a problem has been solved, such as thank you, or an operation indicating that the problem has been solved (S106: Yes), the process ends. Whereas, when the problem is not solved (S106: No), S103 and subsequent steps are repeated.

Furthermore, when the input judgment unit 22 judges that the received inquiry is not registered in the FAQ list DB 13 in S104 (S104: No), the error processing unit 24 executes chat handling (S107).

Specifically, for example, the judgment unit 25 judges whether or not an answer candidate for the received inquiry is registered in the chat handling DB 14 (S108). Then, when it is judged that an answer candidate for the inquiry is registered in the chat handling DOB 14 (S108: Yes), the chat handling unit 26 refers to the chat handling DB 14, randomly selects an answer from a plurality of answers corresponding to the category of the inquiry, and outputs to the chatbot screen 30 (S109).

Whereas, when it is judged that an answer candidate for the inquiry is not registered in the chat handling DB 14 (S108: No), the incomprehension unit 27 outputs an answer randomly selected from the handling list for a case of incomprehension, to the chatbot screen 30 (S110). Then, after S109 or S110 is executed, S103 and subsequent steps are repeated.

[Effects]

As described above, even when an inquiry that may not be expected in advance is inputted, the answering device 10 may respond an answer corresponding to a category of the inquiry, instead of a uniform answer. Furthermore, even when an incomprehensible inquiry that may not be expected as chat handling is inputted, the answering device 10 may respond an answer considering the inputted inquiry, instead of taking routine handling. Therefore, the answering device 10 may provide an opportunity for the user to input the inquiry again, and increase a possibility that the user inputs an inquiry content.

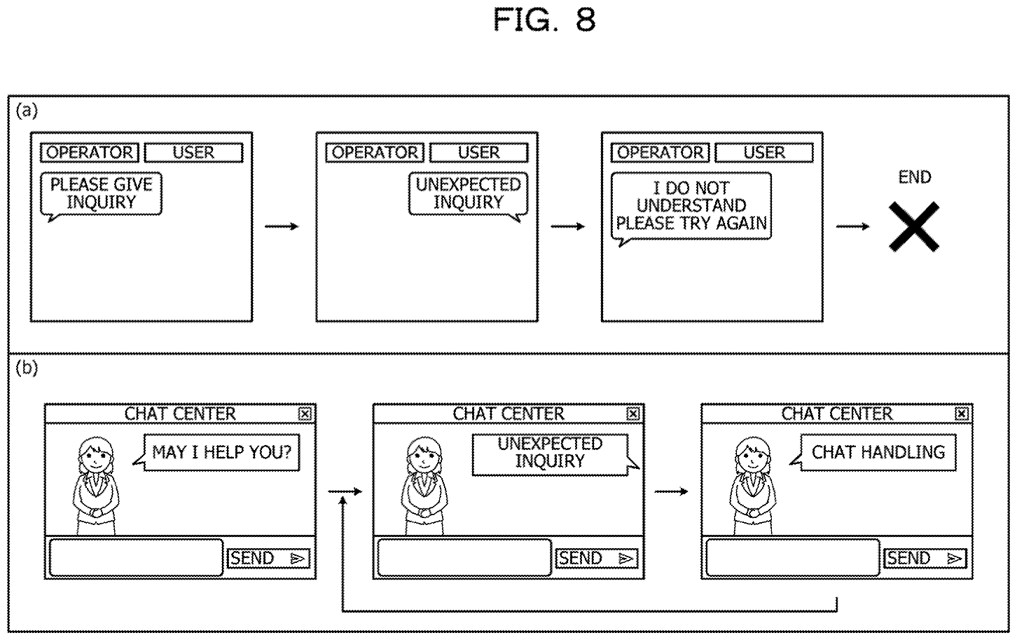

FIG. 8 is a view for explaining a comparative example between the Example and a general technique at a time of an inquiry that does not correspond to the FAQ. As illustrated in (a) of FIG. 8, in a case of a general FAQ system, when a user is prompted to input an inquiry, and then a greeting such as “Good morning” or a slang such as “Gud moning” is inputted, a uniform message such as “I do not understand. Please try again.” is outputted every time regardless of a category of the inquiry. As a result, the user is often bored by such mechanical work and forcibly terminates the FAQ system.

Whereas, as illustrated in (b) of FIG. 8, the answering device 10 according to Example 1 may analyze a category of the inquiry and output an answer corresponding to the analyzed category, when the user is prompted to input an inquiry and then an unexpected inquiry such as a greeting or a slang is inputted. As a result, the answering device 10 may have a chat with the user and continue a conversation, and may provide an opportunity for the user to input an inquiry again. In this way, by executing a technical process of chat handling, the answering device 10 according to Example 1 may improve mechanical work such as a general technique and reduce user's discomfort, making it possible to increase a possibility of including a user's true inquiry from an unexpected inquiry sentence.

### Example 2

Although the Example of the embodiment has been described above, the embodiment may be implemented in various forms in addition to the Example described above.

[Chat Handling]

Information stored in the chat handling DB 14 used at a time of the chat handling as described above may be generated by collecting responses that have continued a conversation, from past responses when inquiries not registered in the FAQ have been received. Furthermore, the chatbot screen 30 is an example, and a general chat screen, an FAQ reception screen, or the like may be similarly processed. Furthermore, an answering device 10 refers to a past inquiry history at a time of chat handling and searches for an answer that has continued conversation. Then, the answering device 10 may also output the retrieved answer as a response to the inquiry. Furthermore, the answering device 10 may also randomly select and respond from a plurality of answers (chat answers) prepared in advance in the chat handling, without preparing a chat handling DB 14.

[Avatar's Action]

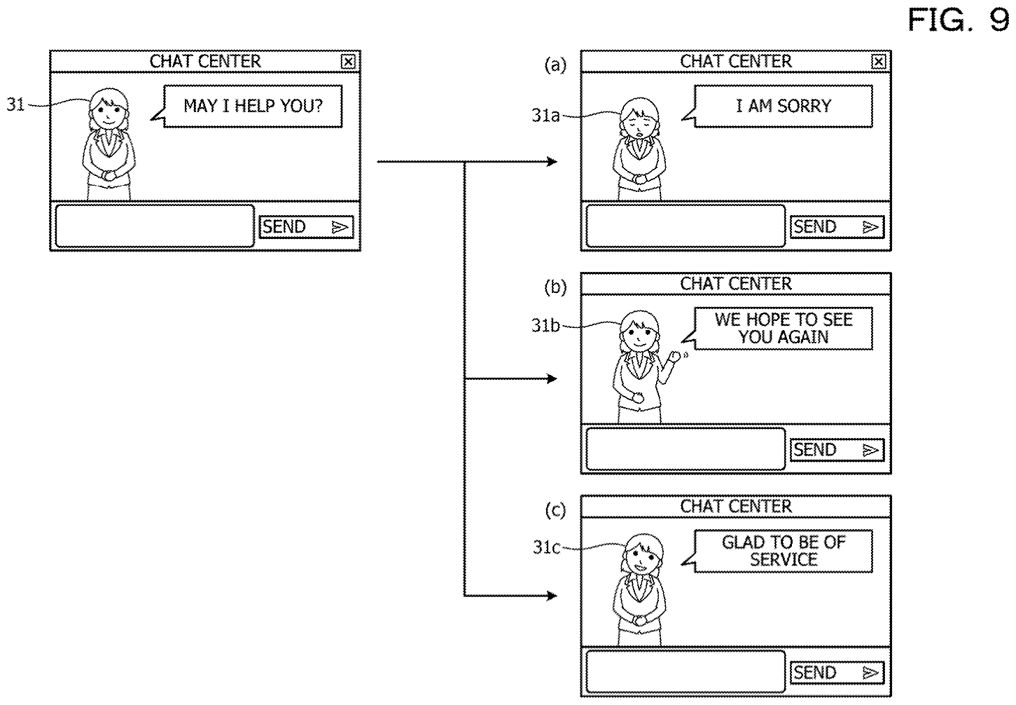

For example, the answering device 10 may cause an action of the avatar 31 of the chatbot screen 30 described in Example 1, in accordance with a content of a response. FIG. 9 is a view for explaining a motion example of the avatar 31. As illustrated in (a) of FIG. 9, the answering device 10 may display an avatar 31a that bows when responding a content of an apology such as “I am sorry”. Furthermore, as illustrated in (b) of FIG. 9, the answering device 10 may display a waving avatar 31b when responding to a content of appreciation such as “We hope to see you again”. As illustrated in (c) of FIG. 9, the answering device 10 may display an avatar 31c that shakes its head sideways with delight and responding “Glad to be of service” or the like, when having high evaluation from the user.

In this way, by associating actions that characterize answers and categories in advance with individual categories and individual answers of the FAQ list DB 13, or individual categories and individual answers of the chat handling DB 14, the answering device 10 may display the avatar 31 that performs a desired action when outputting an answer. Note that the action of the avatar 31 is not limited those described in FIG. 9, but various actions such as, an action of “raising both hands” to express joy, “an arm crossing motion” to represent thinking, “a motion to raise one hand” to request re-input, and the like may be adopted.

Furthermore, the answering device 10 may also hold a dictionary in which a word indicating anger, a word indicating an apology, and the like are registered in advance, and may use the dictionary to judge a state of the user. Then, the answering device 10 may display the avatar 31 that performs an action corresponding to the judged user state. Note that this dictionary can also be adopted for category selection at a time of the incomprehension handling described above.

[Answer Selection Method]

In Example 1 described above, a description has been given to an example in which the answering device 10 responds an answer randomly selected from answers associated with the corresponding category at a time of the chat handling, but the embodiment is not limited to this. For example, the answering device 10 may use information that may not be obtained from a content of the inquiry, such as time, the number of inquiries, and a language of the inquiry, to narrow down the answer candidate.

Specifically, for example, in a case where the time at which the unexpected inquiry has been inputted is the morning, the answering device 10 selects and responds an answer including a word used in the morning such as “Good morning” from the selected categories. Furthermore, in a case where an unexpected inquiry or the like is repeated a predetermined number of times or more, the answering device 10 selects and responds an answer including an apology word such as “I'm sorry for many times”, from the answers that belong to the selected category. Furthermore, in a case where a language of the unexpected inquiry or the like is English, the answering device 10 translates the selected answer into English and responds.

[System]

Pieces of information including a processing procedure, a control procedure, a specific name, various types of data, and parameters described above in the document or illustrated in the drawings may be changed in any ways unless otherwise specified. Furthermore, the specific examples, distributions, numerical values, and the like described in the Examples are merely examples, and may be changed in any ways.

Furthermore, the individual constituent elements of individual devices illustrated in the drawings are functionally conceptual and do not necessarily have to be physically configured as illustrated in the drawings. In other words, for example, specific forms of distribution and integration of the individual devices are not restricted to those illustrated in the drawings. That is, for example, all or a part of the devices may be configured by being functionally or physically distributed and integrated in any units according to various sorts of loads and usage situations. Moreover, all or any part of individual processing functions performed in individual devices may be implemented by a central processing unit (CPU) and a program analyzed and executed by the CPU, or may be implemented as hardware by wired logic.

[Hardware]

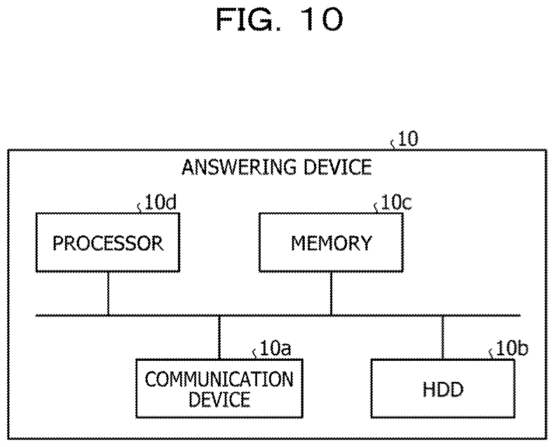

FIG. 10 is a diagram for explaining a hardware configuration example. As illustrated in FIG. 10, the answering device 10 includes a communication device 10a, a hard disk drive (HDD) 10b, a memory 10c, and a processor 10d. Furthermore, the individual units illustrated in FIG. 10 are mutually connected by a bus or the like.

The communication device 10a is a network interface card or the like and communicates with another server. The HDD 10b stores programs and DBs for activating the functions illustrated in FIG. 2.

The processor 10d reads a program that executes processing similar to the process of each processing unit illustrated in FIG. 2 from the HDD 10b or the like, to develop the read program in the memory 10c so as to activate a process that performs each function described with reference to FIG. 2 or the like. In other words, for example, this process executes a function similar to the function of each processing unit included in the answering device 10. Specifically, for example, the processor 10d reads a program having functions similar to those of the screen control unit 21, the input judgment unit 22, the response unit 23, the error processing unit 24, and the like, from the HDD 10b and the like. Then, the processor 10d executes a process for executing processing similar to those of the screen control unit 21, the input judgment unit 22, the response unit 23, the error processing unit 24, and the like.

As described above, the answering device 10 acts as an information processing device that executes an answering method by reading and executing a program. Furthermore, the answering device 10 may also implement functions similar to the functions of the above-described Examples, by reading the program described above from a recording medium by a medium reading device and executing the read program described above. Note that this program referred to in other Example is not limited to being executed by the answering device 10. For example, the embodiment may be similarly applied to a case where another computer or server executes the program, or a case where such computer and server cooperatively execute the program.

This program may be distributed via a network such as the Internet. Furthermore, this program is recorded on a computer-readable recording medium such as a hard disk, flexible disk (FD), compact disc read only memory (CD-ROM), magneto-optical disk (MO), or digital versatile disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an answering program for causing a computer to execute a process comprising:
receiving an inquiry from a terminal;
referring to a memory that stores a content of an inquiry and an answer candidate for the inquiry in association with each other, and judging whether or not an answer candidate for the received inquiry is present;
referring to a past inquiry history and determining information to be outputted to the terminal when it is judged that the answer candidate is absent; and
outputting the determined information.

2. The non-transitory computer-readable recording medium having stored therein an answering program according to claim 1, wherein
the determining includes analyzing the inquiry to identify a category to which the inquiry belongs when it is judged that the answer candidate is absent, and
the outputting includes outputting an answer associated with the identified category to the terminal.

3. The non-transitory computer-readable recording medium having stored therein an answering program according to claim 2, wherein the outputting includes outputting, to the terminal, an answer randomly selected from a plurality of answers associated with the identified category.

4. The non-transitory computer-readable recording medium having stored therein an answering program according to claim 3, wherein the outputting includes outputting, to the terminal, an answer randomly selected from a plurality of answers prepared in advance, when an answer candidate for the inquiry is not stored in the memory and the inquiry does not correspond to the category.

5. The non-transitory computer-readable recording medium having stored therein an answering program according to claim 3, wherein the outputting includes selecting an answer to be outputted from the plurality of answers, by using at least one of time at which the inquiry is received, a number of inquiries inputted until the inquiry is received, or a language of the inquiry.

6. The non-transitory computer-readable recording medium having stored therein an answering program according to claim 2, wherein
the receiving includes displaying, on the terminal, a chat screen displaying an avatar that is a character of a respondent, and receiving the inquiry on the chat screen, and
the outputting includes outputting the answer to the chat screen together with the avatar that performs an action that characterizes the outputted answer.

7. An answering method for causing a computer to execute a process comprising:
receiving an inquiry from a terminal;
referring to a memory that stores a content of an inquiry and an answer candidate for the inquiry in association with each other, and judging whether or not an answer candidate for the received inquiry is present;
referring to a past inquiry history and determining information to be outputted to the terminal when it is judged that the answer candidate is absent; and
outputting the determined information.

8. An answering device comprising:
a memory; and
a processor coupled to the memory and configured to:
receive an Inquiry from a terminal;
refer to the memory that stores a content of an inquiry and an answer candidate for the inquiry in association with each other, and judges whether or not an answer candidate for the received inquiry is present;
refer to a past inquiry history and determines information to be outputted to the terminal when it is judged that the answer candidate is absent; and
output the determined information.
